(19) United States
(12) Patent Application Publication
(10) Pub. No.: US 2005/0201639 A1
(43) Pub. Date: Sep. 15, 2005

(54) SCANNABLE FORM, SYSTEM AND METHOD FOR IMAGE ALIGNMENT AND IDENTIFICATION

(75) Inventor: Xaiojing WU, Burnaby (CA)

Correspondence Address: SEAN W. GOODWIN, 237- 8TH AVE. S.E., SUITE 360, THE BURNS BUILDING, CALGARY, AB, T2G 5C3, CA

(73) Assignee: HARPE AND ASSOCIATES LTD., Calgary (CA)

(21) Appl. No.: 10/906,914

(22) Filed: Mar. 11, 2005

(30) Foreign Application Priority Data
Mar. 12, 2004 (CA) 2,460,888

(51) Int. Cl. G06K 9/32

(52) U.S. Cl. 382/294

(57) ABSTRACT

A scannable form, and a method and system of use which incorporates digitally encoded symbols which have identifiable centers that act as control points to permit a digital image to be aligned with a template containing the same control points. The digital encoding permits identification of the type of form and the spatial arrangement of the symbols permits alignment of the form with the template. Preferably, the digital symbols are geometrically symmetrical and the identifiable centers are centroids. Recognition of any three centroids is sufficient to allow the system to calculate transformation parameters to realign the image. Due to the geometrical symmetry, error correction is possible if any of the symbols are incorrectly identified.

### FIELD OF THE INVENTION

The invention relates to the identification and alignment of scanned images. More particularly, the images contain graphic symbols encoding information related to the form and provide indicators for alignment with a known template for analyzing the data thereon.

### BACKGROUND OF THE INVENTION

Many answer sheet marking and form systems employ pre-printed forms having timing systems which are read and interpreted by specialized scanners.

Other recognition and marking systems use conventional digital scanners. One such system is described in: U.S. Pat. No. 5,936,225 to Arning which teaches a system for identifying a form in an image by comparing vertical and horizontal histograms of the image within the image file to vertical and horizontal histograms of prototype form images in a prototype library. The comparison is achieved using a processor and a form recognition engine. Arning teaches that if a form is skewed or contains unwanted borders and the like, there may possibly be a deskewing or cropping of the image. Arning however does not teach nor contemplate a means for achieving a realignment of the form. Should a form be unrecognizable, a secondary recognition phase is focused on specified areas of the form. Arning does not contemplate large rotations of the images nor does he contemplate erroneous image capture.

In another system taught in U.S. Pat. No. 6,695,216 to Apperson, the system utilizes a mark read scanner for reading forms having graphic switches printed near the lead edge of the form. Each graphic switch or quad switch has four distinct settings which can represent four different characteristics or positions and which is used to identify the family of forms from which the form is derived. The switches utilize black and white designations to allow for binary or quadruple interpretation of marks. The markings on the form also include timing marks which are disposed along one edge of the form and which are associated with an equal number of rows of “bubbles” or marking areas. A skew detector block is provided at or near an opposite edge of the form. If the leader block, timing marks and skew detector block are not detected within a specified period of time, it is assumed that the form was skewed or improperly positioned in the scanner and it is rejected as erroneous and must be re-scanned.

Ideally, what is required is a form that can be scanned using a conventional digital scanner and the image data analyzed to determine the template against which the form is to be compared. Further, it is ideal that the analysis determine whether the image is skewed and then realign the data for comparison with the template without the need to reacquire the image.

### BRIEF DESCRIPTION OF THE DRAWINGS

FIG. 1 illustrates an array of sample graphical symbols of one embodiment of the invention, each symbol having a size of 4×4 that can encode values from 0 to 64. Symbols are surrounded by a black rectangle that has the same line width as a square in the symbol;

FIG. 2 illustrates a sample sheet that can be scanned as an image that employs an embodiment of the invention uses at least two sets of three symbols each, each symbol selected from the array of symbols set forth in FIG. 1; and

FIG. 3 illustrates sample graphical symbols of a size 5×5 that can encode values from 0 to 626.

### SUMMARY OF THE INVENTION

The scannable form, methodology and system of use set forth herein is a novel approach to image alignment and identification. Digitally encoded symbols having centers which define control points are arranged spatially on a form. Following capture of a digital image of the form, the control points are compared to pre-determined control points on a known template of the form. The digital encoding provides information regarding the type of form and the known template while the spatial arrangement permits alignment of the image to the known template. The integrated alignment and identification scheme combines sheet alignment and identification in a single and compact framework.

At least three symbols are spatially arranged on the form and recognition of at least three control points triggers calculation of transformation parameters to align the control points and the image with the pre-determined control points on the template to permit sheet position, rotation and shearing correction.

In one broad aspect of the invention a scannable form having at least one answer response area comprises a generally rectangular sheet; and at least three digitally encoded symbols, each encoded symbol having an identifiable center for forming a control point, the symbols being printed on the sheet in a spatial arrangement relative to the at least one answer response area, wherein when the form is scanned as an image, the control points in the image are compared to pre-determined control points in a known template for determining an alignment of the image with the known template.

In another broad aspect of the invention, a method for image alignment and recognition of a scannable form comprises: providing a plurality of digitally encoded symbols, each symbol encoding a unique number or character, and having an identifiable center for forming a control point; positioning at least three of the plurality of digitally encoded symbols on the scannable form in a spatial arrangement; generating a digital image of the scannable form including the spatial arrangement; identifying a known template having pre-determined control points for comparison of the scannable form thereto; and determining the spatial arrangement of the control points in the digital image of at least three of the at least three digitally encoded symbols for determining alignment of the digital image compared to pre-determined control points of the known template.

A system for preparing, administering and marking an examination comprising: creating an examination having a plurality of user-defined questions; selecting an answer sheet template from a plurality of customizable templates and customizing the template to contain markings representative of the answers to the plurality of user-defined questions; printing a plurality of examination response sheets using the selected answer sheet template and having at least three digitally encoded symbols printed thereon, each symbol encoding a unique number or character for identification of the template, and each symbol having a center wherein the at least three digitally encoded symbols form at least three control points, the at least three control points being positioned on the plurality of response sheets in a spatial arrangement to permit recognition of an alignment of each of the printed answer sheets; administering the examination, each exam answer sheet being marked at predetermined locations to indicate an answer to each of the plurality of user-defined questions; scanning each of the plurality of answer sheets for forming a scanned digital image; processing the scanned digital images for determining a location of the at least three control points for aligning each answer sheet with the known template; and if aligned, comparing the scanned digital image to the template for matching markings thereon for scoring the answer sheet.

Preferably, the symbols are geometrically symmetrical and have a fixed center of mass or centroid. The geometrical symmetry permits error correction should a symbol be incorrectly decoded. Adjacent symbols have a first hamming distance and non-adjacent symbols have a second fixed hamming distance. Determining the position of the symbol relative to the other symbols on the image permits the system to predict the identity of the misidentified symbol. Further, when operated in a batch mode, the system can utilize data from previous scanned forms to assist in the prediction.

In one embodiment, the methodology is applied to the interpretation of scanned forms or examination marking sheets. Identification and alignment can be applied however to any image incorporating symbols as described in embodiments of the present invention arranged in a spatial arrangement in the image.

### DETAILED DESCRIPTION OF THE PREFERRED EMBODIMENT

For convenience, embodiments of the invention are described herein in one possible context of images obtained from scanned forms, such as examination bubble-type answer forms on which students have marked test answers. Once the type of form is recognized, the form image is aligned for comparison to a known and corresponding template and response data fields are located therein using embodiments of the invention, known methodologies are available for extracting markings representative of data input placed onto the form, such as answers on a test sheet.

Symbols

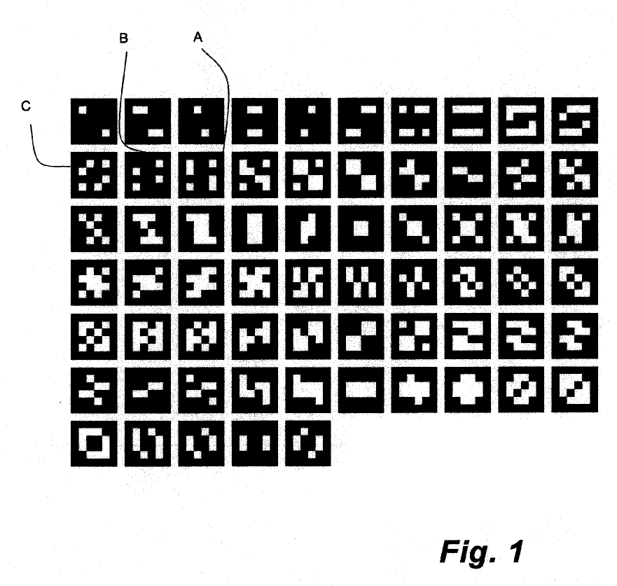

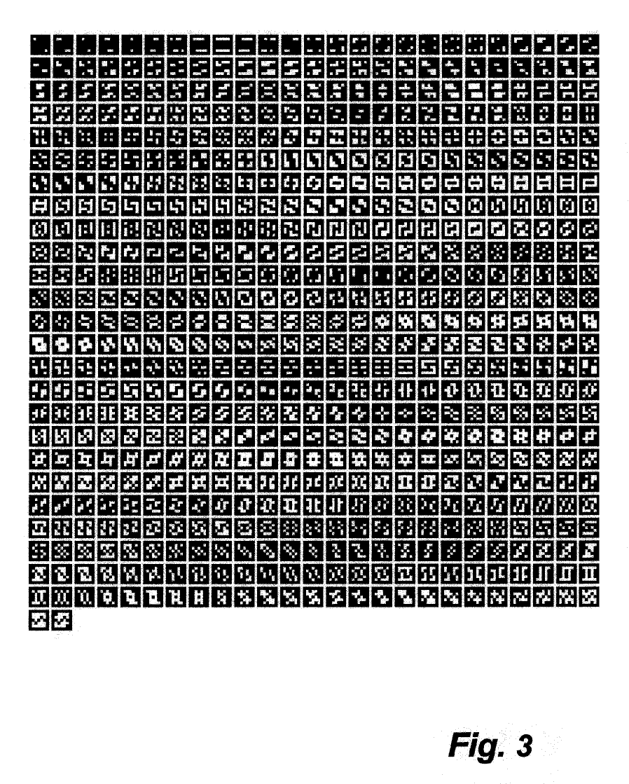

As shown in FIGS. 1 and 3, a plurality of symbols are provided which assist in determining the alignment of the image and realigning the image to a known template having pre-determined control points, if required and may be used to identify the form type and known template to which the form is to be compared. Optionally, a user may provide the system with the identity of the known template manually, such as in a case where symbols encoding template information are not recognized properly. In this case the symbols on the form are used solely for alignment purposes.

Each symbol contains unique encoded data in a matrix of data modules, each data module representing a data bit. The data modules are either light, preferably white, or are dark, preferably black. A border, formed about each symbol's matrix, has a line width equivalent to the width of a data module. As shown in FIG. 1, symbols may utilize a 4×4 matrix which can encode 65 unique values. As shown in FIG. 3, symbols may utilize a 5×5 matrix which can encode 627 unique values.

Each white and black square in a symbol represents a bit, 0 or 1, respectively, permitting complete digital encoding. For example, the first symbol in FIG. 1 has a representation, in bits, of 0111 1111 1111 1110. More information on various forms of symbols can be found in the standards defined by ANSI/AIM BC11, International Symbology Specification called “Data Matrix”. Data Matrix is a two-dimensional matrix symbology containing the dark and light square data modules. In conventional use, Data Matrix is designed with a fixed level of error correction capability.

Each of the symbols in FIGS. 1 and 3 has an identifiable center which acts as a control point to aid in determining the alignment of the scanned image. Preferably, the symbols are geometrically symmetrical having a fixed center of mass, or centroid. As a result of the geometric symmetry, regardless the alignment of the form when scanned, the unique encoded data is recognizable and is not corrupted as a result of sheet misalignment. The symbols are thus invariant in theory and stable in practice with respect to any affine transformation required to correct for the misalignment, such as shift, rotation and shearing, and to bring the image into alignment for comparison to the template.

An affine transformation is a geometrical transformation that can be precisely modeled as:
Y=AX (1)

In the matrix form, it looks like the following

$$[ \begin{matrix}{x}^{′} \\ {y}^{′} \\ 1\end{matrix} ] = [ \begin{matrix}a & b & c \\ d & e & f \\ 0 & 0 & 1\end{matrix} ] [ \begin{matrix}x \\ y \\ 1\end{matrix} ] \qquad ( 2 )$$

A is a 3×3 nonsingular transformation matrix and has only 6 free parameters. X represents the coordinates of a point before transformation and Y represents the transformed coordinates of the same point.

The symmetry of the symbols greatly improves signal to noise ratio (SNR) assuming noise is random, as it is highly unlikely that a random noise would contaminate a symbol in a symmetric way. Digital encoding makes the symbols highly resistant to random noises which are prevalent in image scanning.

A set of three 4×4 symbols can encode up to 274,625 (65³) templates. In a commercial situation wherein a provider supplies particular templates to an end user, the provider can reserve a block of symbols for the sheets or templates created only by the provider, leaving a plethora of unique symbols for other uses by the end user.

Spatial Arrangement

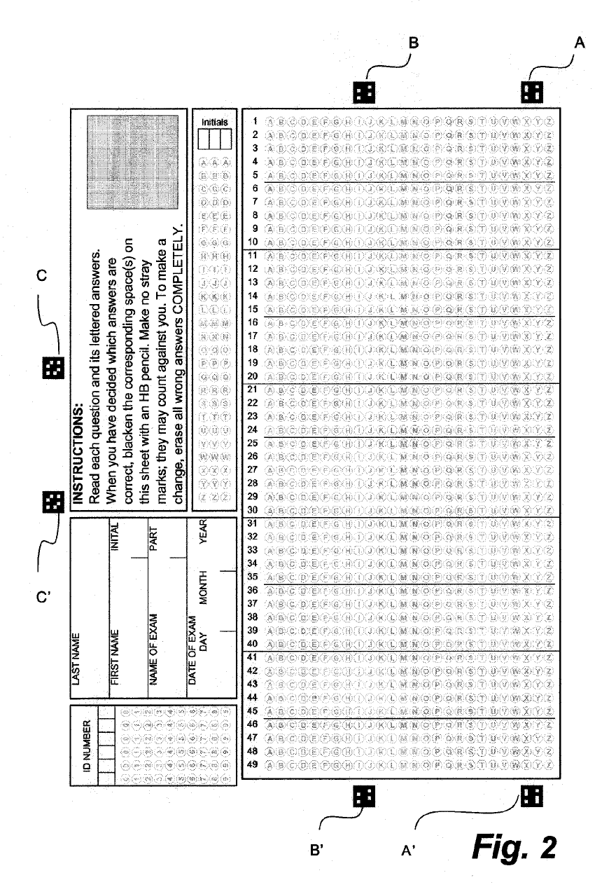

As shown in FIG. 2, each of the plurality of symbols printed on the form serves as a control point in determining the alignment of the image and in calculating transformation parameters utilized in re-alignment of the image for comparison to the template, if required. Embodiments of the invention provide a space-efficient system easily placed on any image or form.

The positions of the symbols on the form aid in minimizing errors caused by non-uniform image formation, which is a common error resulting from scanning speed variation.

After a form has been identified, the centers or centroids of the symbols are calculated. Each symbol or control point detected is matched with a symbol or control point on the known template. A minimum of three or more matching symbols or control points is required to calculate the transformation parameters (a, b, c, d, e, f as seen in Formula (1), matrix (2)), which are optimally estimated using a least square criterion,

$$min {\sum }_{i = 1}^{n} {( {p}_{e}^{i} - {p}_{t}^{i} )}^{2} \qquad ( 3 )$$

where
pₑ is the estimated aligned position,
pᵢ is the detected position from the detected template.

The pₑ's are calculated using formula (2) as noted above, and therefore criterion (3) can be expanded out in terms of transformation parameters a, b, c, d, e, f. This is an often used and very effect way to best estimate transformation parameters. Once transformation parameters are calculated, a direct geometrical transformation modeled by equation (1) is performed to transform a sheet image to align exactly with the detected template.

Embodiments of the methodology of the invention use at least three symbols in an image for providing the minimum data necessary for affine transformation for alignment with the known template. Typically therefore, a first set of three symbols is selected from the plurality of symbols and is used to encode the form.

Preferably, the form further comprises a second, redundant set of symbols, to provide robustness to the system, each set being equally useful and effective in providing information for alignment of the image. The second redundant set of symbols comprises at least two symbols and in combination with the first set must provide a cumulative number equaling three symbols. The second redundant set of symbols preferably comprises symbols which correspond with the first set of symbols, for example, each of the three symbols of the first set having a companion symbol, arranged in pairs. Preferably, the second redundant set of symbols comprises substantially identical symbols to the first set of symbols and the matching symbols from each pair of symbols is placed at roughly the same position on the form, allowing the system to detect which symbol may be missing in the case of a scanning error.

Use of two fully redundant sets of symbols permits alignment regardless of an enormously high error rate. Errors are non-recoverable only if both symbols in a pair of symbols are missed or erroneously detected, which is highly unlikely considering that given the spatial arrangement symbols within a pair of symbols are positioned geometrically far apart. Although the symbols are redundant in terms of encoding, they are not redundant at all in terms of helping sheet alignment.

The system is designed to detect those symbols which may be missing as a result of burst errors typically caused by disruptions in the collection of data from the form during scanning. Burst errors might also be caused by such events as scratches or additional markings on the form and the like.

In the case where a symbol's encoded value is interpreted incorrectly, that is the symbol is interpreted to be another symbol, sheet alignment is still possible using the position of the symbol as the symmetry of the symbol is corrupted in a symmetrical manner. In the case of unsuccessful initial decoding of the symbol, the system would guess or predict what is most likely to be the correct interpretation. The symbols are designed and arranged in a spatial array to ensure that adjacent symbols, such as symbols representing consecutive encoded values as shown in FIG. 1, have a first fixed hamming distance of 2 and non-adjacent symbols have a second hamming distance of at least 4. The hamming distance between two symbols is simply the number of bits that are different, for example 0110 and 1010 have a hamming distance of 2. The system selects the symbol that has the least hamming distance with the symbol decoding and does further image analysis to determine what is the most likely value.

Further, when processing of forms is operated in a batch mode and in case of error, the system takes advantage of the data on the previously recognized forms to predict that what follows is very likely to be the same as what has already been processed. That is, the program analyzing the image can predict the erroneously detected or non-detected symbol from a subset of the plurality of symbols from the neighboring forms, instead of from the whole symbol set, to compute the hamming distance with the symbol decoding. In this case, if the neighboring symbols do not provide a symbol having the appropriate hamming distance, the whole symbol set is used. Use of hamming distance aids in efficient operation and allows the program to efficiently guess what might be the correct values.

### EXAMPLE

Having reference again to FIG. 2, a form according to an embodiment of the invention is shown, illustrating the use of a set of three geometrically symmetric symbols and a redundant set of three identical geometrically symmetric symbols. The first set of symbols are identified as A, B and C. The redundant set of symbols is identified as having corresponding symbols A′, B′ and C′. Symbols A and A′ are a pair, as are B and B′ and C and C′. The hamming distances, comparing adjacent and non-adjacent symbols is represented in Table A.

TABLE A

| | |
|---|---|
| B | 1110 0111 1110 0111 |
| A | 0110 0111 1110 0110 |
| Adjacent | 1000 0000 0000 0001 = 2 |
| B | 1110 0111 1110 0111 |
| C | 1010 0111 1110 0101 |
| Adjacent | 0100 0000 0000 0010 = 2 |
| A | 0110 0111 1110 0110 |
| C | 1010 0111 1110 0101 |
| Non-adjacent | 1100 0000 0000 0011 = 4 |

In the embodiment shown in FIG. 2, a primary or first set of three unique 2D symbols is provided in an upper portion of the form. Two of the unique symbols A, B are spaced horizontally along the top margin and one C is placed in the left margin. A second backup or redundant set of identical symbols is provided in a lower portion of the form, forming pairs of symbols when combined with the first set of symbols. Two of the redundant symbols A′, B′ are positioned in the bottom margin and the third redundant symbol C′ is positioned in the left margin, the identical symbols of each pair being positioned at roughly the same horizontal position on the form, referenced from the left or right margin.

The top two symbols A,B roughly represent the middle and the right end of the sheet, horizontally. The two left symbols C, C′ roughly represent one third to the middle of the sheet, vertically. The bottom two symbols A′, B′ represent the middle and the right end of sheet, horizontally, at the bottom. For the embodiment illustrated, the spatial arrangement of symbols is more robust than other spatial arrangements, such as positioning symbols in all four corners, because the positions of the symbols closely represent the geometrical distribution of the answer bubbles, as shown on the form in FIG. 2, and allows a program to use a high level algorithm, such as the least sum of squared distances shown in Formula (2) to better estimate the transformation parameters for sheet alignment.

Symbols from both the first and the second redundant set have fixed individual, as well as set encoding rules In the example shown in FIG. 2, A,B, and C represent symbols 12, 11 and 10, respectively, according to FIG. 1, where the first symbol is 0. Together ABC represents a value of 51,425 (12×65²+11×65+10). Any three individual symbols, including symbols from the first and second redundant sets can be employed in estimating the transformation parameters.

Each of the 2D symbols represents a digitally encoded value using 2 or more high contrast designations. Once the form is identified, all the relevant information associated with the form is dynamically loaded into the system from a database. The relevant information can be, but is not limited to, the relative positions of the symbols, answer bubble positions, bubble group rules, and output representation format.

The redundancy or backup sets of symbols are optional and may be eliminated in situations where a high identification rate is not required. In this case, the first and only set of symbols should consist of at least three symbols to permit full affine transformation alignment.

An exact image of every form or exam sheet can be created using any digital scanner and the image can be easily stored in electronic format. This eliminates the need for paper copies of exams and storage associated therewith. A typical implementation in a school examination scenario includes: creating the exam choosing from a set of customizable templates, printing the exam having symbols, arranged on the form according to embodiments of the invention, thereon, the exam being economically printed on plain paper with any laser printer, administering the exam allowing for the use of virtually any pencil or pen for marking, scanning the exams with a digital scanner storing them as images, processing the scanned images using the current invention for accurately identifying, aligning the exams and therefore correctly recording the exam answers, and scoring the exams and generate reports for students and teachers.

1. A scannable form having at least one answer response area comprising:
a generally rectangular sheet; and
at least three digitally encoded symbols, each encoded symbol having an identifiable center for forming a control point, the symbols being printed on the sheet in a spatial arrangement relative to the at least one answer response area,
wherein when the form is scanned as an image, the control points in the image are compared to pre-determined control points in a known template for determining an alignment of the image with the known template.

2. The scannable form as described in claim 1 wherein recognition of three or more of the identifiable centers of the at least three digitally encoded symbols triggers calculation of transformation parameters for alignment of the image with the known template.

3. The scannable form as described in claim 1 wherein the symbols are geometrically symmetrical and have a fixed centroid for forming the control point.

4. The scannable form as described in claim 1 wherein the at least three digitally encoded symbols are a first set of the plurality of digitally encoded symbols.

5. The scannable form as described in claim 4 further comprising at least one additional redundant set of symbols.

6. The scannable form as described in claim 5 wherein the cumulative number of symbols in the first set and the at least one additional redundant set is three symbols.

7. The scannable form as described in claim 6 wherein the at least one redundant set of symbols comprises substantially identical symbols to the first set of symbols and the substantially identical symbols are arranged in pairs, each symbol of the pair being positioned at substantially the same horizontal position on the sheet.

8. A method for image alignment and recognition of a scannable form comprising:
providing a plurality of digitally encoded symbols, each symbol encoding a unique number or character, and having an identifiable center for forming a control point;
positioning at least three of the plurality of digitally encoded symbols on the scannable form in a spatial arrangement;
generating a digital image of the scannable form including the spatial arrangement;
identifying a known template having pre-determined control points for comparison of the scannable form thereto; and
determining the spatial arrangement of the control points in the digital image of at least three of the at least three digitally encoded symbols for determining alignment of the digital image compared to pre-determined control points of the known template.

9. The method as described in claim 8 wherein the digitally encoded symbols are decoded to identify the known template for comparison thereto.

10. The method as described in claim 8 wherein the template is identified manually by a user for comparison thereto.

11. The method as described in claim 8 wherein the digitally encoded symbols are geometrically symmetrical and have a fixed centroid for forming the control point.

12. The method as described in claim 8 wherein the at least three digitally encoded symbols are a first set of the plurality of digitally encoded symbols.

13. The method as described in claim 12 further comprising at least one additional redundant set of symbols.

14. The method as described in claim 13 wherein the cumulative number of symbols in the first set and the at least one additional redundant set is three symbols.

15. The method as described in claim 13 wherein the at least one redundant set of symbols comprises substantially identical symbols to the first set of symbols and the substantially identical symbols are arranged in pairs, each symbol of the pair being positioned at substantially the same horizontal position on the sheet.

16. The method as described in claim 8 wherein each of the encoded symbols has a control point for recognition of the alignment of the digital image.

17. The method as described in claim 8 wherein recognition of three or more of the at least three digitally encoded symbols triggers calculation of transformation parameters for alignment of the digital imate with the known template.

18. The method as described in claim 8 wherein each symbol is a two-dimensional matrix having light and dark data modules, each module representing a data bit.

19. The method as described in claim 18 wherein the two-dimensional matrix is a 4×4 matrix.

20. The method as described in claim 18 wherein the two-dimensional matrix is a 5×5 matrix.

21. The method as described in claim 18 wherein each two-dimensional matrix is contained in a border having a line width substantially equivalent to a width of an individual module within the symbol.

22. The method as described in claim 8 wherein when at least a portion of a symbol encoding is erroneous and wherein the spatial arrangement comprises:
providing adjacent symbols, all adjacent symbols having a first fixed hamming distance and providing non-adjacent symbols, all on-adjacent symbols having a second hamming distance;
further comprising:
determining whether the at least a portion of the identified symbol is adjacent another symbol and should have the first fixed hamming distance or is not adjacent another symbol and should have the second fixed hamming distance; and
predicting the identity of the erroneously encoded symbol by selecting a symbol from the plurality of symbols as being the symbol having the first or second fixed hamming distance.

23. The method as described in claim 22 wherein when the sheets are recognized as a batch in a batch mode, further comprising:
predicting the identity of the erroneously encoded symbol by selecting a symbol from the symbols identified for neighbors in the batch having the least hamming distance.

24. The method as described in claim 23 further wherein a symbol having the fixed hamming distance is not found in the symbols identified for neighbours in the batch further comprising:
predicting the identity of the erroneously encoded symbol by selecting a symbol from the plurality of symbols as being the symbol having the least hamming distance.

25. The method as described in claim 15 wherein when at least one symbol of the first set of symbols or the redundant set of symbols is not recognized further comprising:
predicting the identity of the unrecognized symbol from the symbol of the pair being positioned at substantially the same horizontal position on the sheet.

26. A method for image alignment and recognition comprising:
providing a plurality of digitally encoded symbols, each symbol encoding a unique number or character, and being geometrically symmetrical and having a fixed centroid for forming a control point;
positioning at least three of the plurality of digitally encoded symbols on the scannable form in a spatial arrangement;
generating a digital image of the scannable form including the spatial arrangement;
identifying a known template having pre-determined control points for comparison of the scannable form thereto; and
determining the spatial arrangement of the centroids of at least three of the at least three digitally encoded symbols for determining alignment of the digital image compared to the known template.

27. The method as described in claim 26 wherein the at least three digitally encoded symbols are a first set of the plurality of digitally encoded symbols.

28. The method as described in claim 27 further comprising at least one additional redundant set of symbols.

29. The method as described in claim 28 wherein the cumulative number of symbols in the first set and the at least one additional redundant set is three symbols.

30. The method as described in claim 28 wherein the at least one redundant set of symbols comprises substantially identical symbols to the first set of symbols and the substantially identical symbols are arranged in pairs, each symbol of the pair being positioned at substantially the same horizontal position on the sheet.

31. The method as described in claim 26 wherein each of the encoded symbols has a control point for recognition of the alignment of the digital image.

32. The method as described in claim 26 wherein recognition of three or more of the at least three digitally encoded symbols triggers calculation of transformation parameters for alignment of the digital image with the known template.

33. A system for preparing, administering and marking an examination comprising:
creating an examination having a plurality of user-defined questions;
selecting an answer sheet template from a plurality of customizable templates and customizing the template to contain markings representative of the answers to the plurality of user-defined questions;
printing a plurality of examination response sheets using the selected answer sheet template and having at least three digitally encoded symbols printed thereon, each symbol encoding a unique number or character for identification of the template, and each symbol having a center wherein the at least three digitally encoded symbols form at least three control points, the at least three control points being positioned on the plurality of response sheets in a spatial arrangement to permit recognition of an alignment of each of the printed answer sheets;
administering the examination, each exam answer sheet being marked at predetermined locations to indicate an answer to each of the plurality of user-defined questions;
scanning each of the plurality of answer sheets for forming a scanned digital image;
processing the scanned digital images for determining a location of the at least three control points for aligning each answer sheet with the known template; and
if aligned, comparing the scanned digital image to the template for matching markings thereon for scoring the answer sheet.

34. The system as described in claim 33 wherein each of the symbols is geometrically symmetrical and has a fixed centroid for forming the control point.

35. The system as described in claim 34 wherein recognition of three or more of the at least three centroids of the digitally encoded symbols triggers calculation of transformation parameters for alignment of the sheet with the known template.
